(19) United States
(12) Patent Application Publication
(10) Pub. No.: US 2017/0317999 A1
(43) Pub. Date: Nov. 2, 2017

(54) SECURITY CREDENTIAL PROTECTION WITH CLOUD SERVICES

(71) Applicant: Cisco Technology, Inc., San Jose, CA (US)

(72) Inventors: Denis Knjazihhin, Lexington, MA (US); Yedidya Dotan, Newton, MA (US); Christopher Duane, Groton, MA (US); Jason M. Perry, Plymouth, MA (US)

(21) Appl. No.: 15/139,750

(22) Filed: Apr. 27, 2016

(51) Int. Cl. H04L 29/06; G06F 9/44; H04L 29/08

(52) U.S. Cl. CPC H04L 63/08; H04L 67/28; G06F 9/4416; H04L 63/10

(57) ABSTRACT

Presented herein are techniques for remotely releasing bootstrap credentials to a cloud management proxy device. In particular, a cloud management proxy device that is associated with a cloud system commences a boot operation. The cloud management proxy device then initiates a remote credential release process to obtain the bootstrap credentials, which are useable by the cloud management proxy device to complete the boot operation. Upon completion of the remote credential release process, the bootstrap credentials are received from a remote credential manager system.

### TECHNICAL FIELD

The present disclosure relates to managing network security and similar devices.

### BACKGROUND

Cloud services have been created to provide network security management to different tenants/customers (e.g., Company 1, Company 2, Company 3, and so on). These cloud services, which are sometimes referred to herein as network security management cloud services, generally include a cloud-based management entity that is responsible for managing, for example, the policies of the network security devices for each customer. Network security management cloud services generally provide a point-of-entry into the cloud service for each of the different customers. The customers may each also be associated with one or more on-premises or cloud-based environments from which the cloud service may be accessed.

### BRIEF DESCRIPTION OF THE DRAWINGS

FIG. 1 illustrates a cloud-based management system for management of network security devices in which the techniques presented herein may be implemented, according to an example embodiment.

FIG. 2 is a flow chart for a process to provide bootstrap credentials to a cloud management proxy device, according to an example embodiment.

FIG. 3 is a ladder diagram illustrating messages exchanged to provide bootstrap credentials to a cloud management proxy device, according to an example embodiment

FIG. 4 is a generalized flow chart for a process to provide bootstrap credentials to a cloud management proxy device, according to an example embodiment.

FIG. 5 is a block diagram illustrating an example hardware configuration for a cloud management proxy device on which operations described herein may be executed, according to an example embodiment.

### DESCRIPTION OF EXAMPLE EMBODIMENTS

### Overview

Presented herein are techniques for remotely releasing bootstrap credentials to a cloud management proxy device. In particular, a cloud management proxy device that is associated with a cloud system commences a boot operation. The cloud management proxy device then initiates a remote credential release process to obtain the bootstrap credentials, which are useable by the cloud management proxy device to complete the boot operation. Upon completion of the remote credential release process, the bootstrap credentials are received from a remote credential manager system.

### DETAILED DESCRIPTION

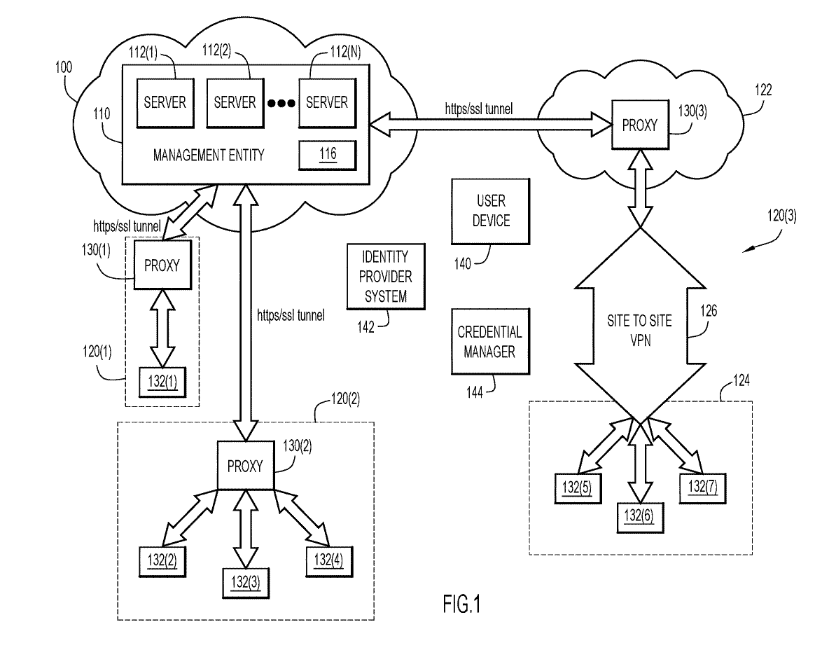

With reference to FIG. 1, there is shown a cloud-based management system 100 that is configured to provide network security management (i.e., management of the policies for network security devices) for multiple tenants/customers in a cloud environment. Because the cloud-based management system 100 is responsible for managing, for example, the policies of the network security devices for each of a plurality of customers, the cloud-based management system 100 is sometimes referred to herein as a network security cloud system or service.

FIG. 1 illustrates three (3) customer environments in which deployed customer network security devices are managed by the cloud-based management system 100. The example customer environments of FIG. 1 include a perimeter network or demilitarized zone (DMZ) 120(1) associated with a first customer (customer A), an internal network 120(2) also associated with the first customer, and a network 120(3) associated with a second customer (customer B). Network 120(3) associated with the second customer is formed by a virtual private cloud (VPC) portion 122 and a local portion 124 interconnected by a site-to-site virtual private network (VPN) 126. FIG. 1 shows three customer environments, but it should be understood that the cloud-based management system 100 might connect and communicate with multiple customer environments.

Each of the customer environments 120(1), 120(2), and 120(3) includes one or more network security devices, which are also sometimes referred to as network security appliances. In the example arrangement of FIG. 1, environment 120(1) includes a network security device 132(1), environment 120(2) includes network security devices 132(2), 132(3), and 132(4), and environment 120(3) includes network security devices 132(5), 132(6), and 132(7). The network security devices 132(1)-132(7) may be implemented in hardware and/or software and may comprise, for example, firewalls, gateways, intrusion detection systems, intrusion prevention systems, and other types of security appliances/products. Within a customer environment, there are one or more resources (not shown in FIG. 1) and one or more actors (also not shown in FIG. 1). The resources may include servers, databases, and the actors are users or processes using a computing device (personal computer, SmartPhone, laptop computer, etc.) that may seek access to one or more of the resources. The resources and actors may also reside outside the customer datacenter itself, e.g., in the Internet. The network security devices 132(1)-130(7) control access of the actors to the resources according to network security policies, e.g., sets of one or more network security rules configured on the respective network security devices.

The cloud-based management system 100 includes a cloud management entity 110 that consists of one or more computer servers 112(1)-112(M) which communicate with network security devices 132(1)-130(7) deployed in the customer environments (e.g., on the cloud or on-premises). The management entity 110 connects to the security devices 132(1)-130(7) deployed in the cloud or on the customers' premise to install and/or configure one or more network security policies on network security devices 132(1)-130(7). The connection includes, for example, a Secure Sockets Layer (SSL) or Hyper Text Transfer Protocol Secure (HTTPS) tunnel enabled by the cloud management proxy devices 130(1), 130(2), and 130(3) in the corresponding location.

In general, the cloud management proxy devices 130(1), 130(2), and 130(3) are customer specific devices that are configured to manage the connection of the management entity 110 to the network security devices. The cloud management proxy devices 130(1), 130(2), and 130(3) are also configured to address the location and security of the network security device security credentials (security keys). That is, the cloud management proxy devices 130(1), 130(2), and 130(3) are machines (e.g., virtual machines) that control access to all of the various credentials needed to access and control the configurations/settings of the corresponding network security devices 132(1)-130(7) (i.e., cloud management proxy device 130(1) controls access to credentials associated with network security device 132(1), cloud management proxy device 130(2) controls access to credentials associated with network security devices 132(2), 132(3), and 132(4), and cloud management proxy device 130(3) controls access to credentials associated with network security devices 132(5), 132(6), and 132(7)).

Although FIG. 1 illustrates three cloud management proxy devices 130(1), 130(2), and 130(3), it is to be appreciated that other numbers of cloud management proxy devices may be provided. It is also to be appreciated that cloud management proxy devices in accordance with examples presented herein may run either in the cloud or on the customer premises.

The cloud management proxy devices 130(1), 130(2), and 130(3) store and control access to the security credentials that are, in turn, useable to access the network security devices 132(1)-130(7). If an attacker (hacker) were able to obtain these security credentials, the attacker would have the ability change the configuration/settings of the network security devices 132(1)-130(7) and, for example, damage the customer networks, access proprietary/sensitive information, and other malicious activity. As a result, protection of the security credentials needed for access to these security devices 132(1)-132(7) is of critical concern to network administrators, resulting in the addition of security mechanisms to the cloud management proxy devices 130(1), 130(2), and 130(3). One of these additional security mechanisms is that a cloud management proxy device 130(1), 130(2), and 130(3) cannot complete a boot operation without the cloud management proxy device first obtaining some initial start-up credentials. These start-up credentials, sometimes referred to here as boot or bootstrap credentials, are used by the cloud management proxy device to unlock its configuration/settings and to access the stored security credentials for the associated network security devices. That is, the security credentials for the network security devices, which are stored on the associated cloud management proxy device, cannot be accessed by the cloud management proxy device until it is authenticated and provided with the bootstrap credentials.

In computing, a boot operation (also known as booting or booting up) is the initial set of operations that a device performs when, for example, electrical power is supplied to the device, the device restarts, etc. The process begins when a device that has been turned off is initially energized/re-energized, and ends when the device is ready to perform its normal operations. Therefore, a problem arises when the cloud management proxy devices 130(1), 130(2), and 130(3) undergo a boot operation (boots) because, as noted above, some form of bootstrap credentials are needed by the cloud management proxy devices 130(1), 130(2), and 130(3) themselves in order to complete the boot operation. This problem is compounded in a cloud-based remote environment because it is cumbersome to require a network administrator to locally log into the cloud management proxy devices 130(1), 130(2), and 130(3) (i.e., directly enter information at the devices themselves) to provide access to the bootstrap credentials every time the cloud management proxy devices 130(1), 130(2), and 130(3) boot, which could occur often. As such, presented herein are techniques for providing cloud management proxy devices 130(1), 130(2), and 130(3) with the bootstrap credentials needed in order to complete its boot operation through a remote credential release process. As used herein, a remote credential release process is a process executed outside of a cloud management proxy device that causes a user to authorize a release of the bootstrap credentials to the cloud management proxy device.

More specifically, as described further below, the bootstrap credentials are obtained through a use of a client or user device 140, such as a mobile computing device, an identity provider (IdP) system 142, and a credential or key manager 144. The identity provider system 142 is an online service or website that authenticates users on the Internet by means of security tokens. The identity provider system 142 is responsible for: (1) providing identifiers for users looking to interact with a system, (1) asserting to such a system that such an identifier presented by a user is known to the provider, and (3) possibly providing other information about the user that is known to the provider. This may be achieved via an authentication module which verifies a security token that can be accepted as an alternative to repeatedly explicitly authenticating a user within a security realm.

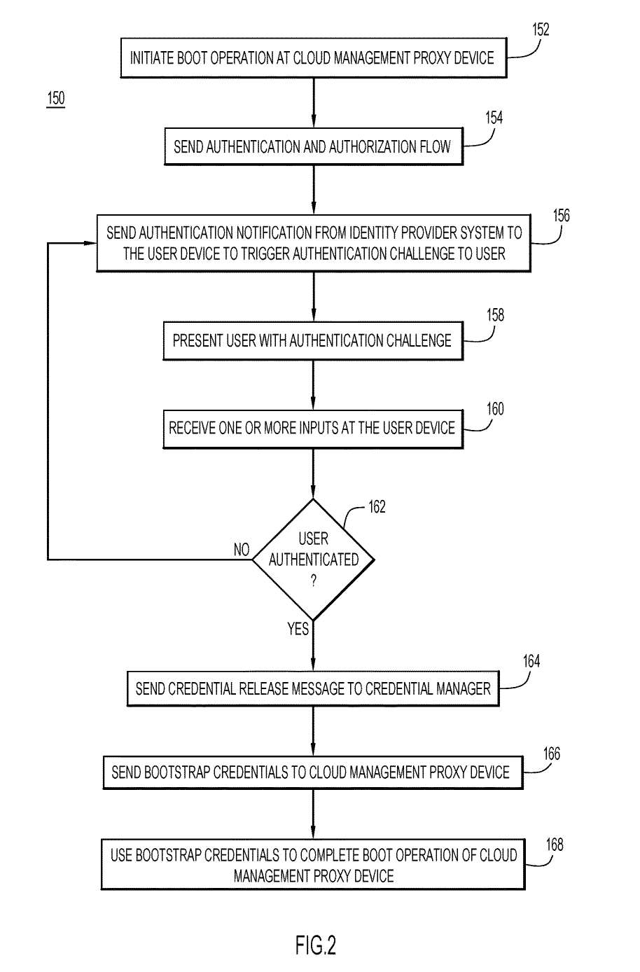

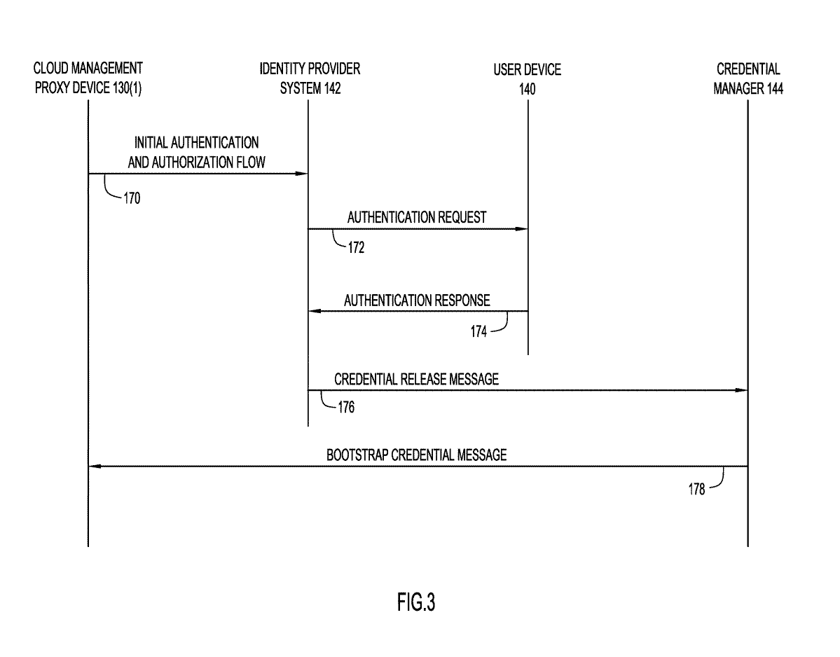

FIG. 2 is a flowchart illustrating a method 150 for providing bootstrap credentials to a cloud management proxy device through the use of a remote credential release process. FIG. 3 is a flow diagram illustrating the exchange of messages in the method of FIG. 2. For ease of description, FIGS. 2 and 3 are described together with reference to the arrangement of FIG. 1 and, more particularly, with reference to providing bootstrap credentials to cloud management proxy device 130(1).

Method 150 begins at 152 where the cloud management proxy device 130(1) initiates a boot operation. Initiation of the boot operation triggers, at 154, the sending of an initial authentication and authorization flow (e.g., an Extensible Markup Language (XML) flow, such as a Security Assertion Markup Language (SAML) 2.0 flow, an HTTPS flow, etc.) towards the cloud-based management system 100. The initial authentication and authorization flow includes identity information, such as an ephemeral machine key or user identifier (ID), associated with the cloud management proxy device 130(1). Although the initial authentication and authorization flow is issued towards the cloud-based management system 100, a redirect of this flow is made to the identity provider system 142. The initial authentication and authorization flow generated by the cloud management proxy device 130(1), and the re-direction of this flow to the identity provider system 142, is shown in FIG. 3 by arrow 170. Once the initial authentication and authorization flow 170 is issued towards the cloud-based management system 100, the cloud management proxy device 130(1) enters a “waiting” state in which the boot operation is paused until receipt of the bootstrap credentials.

At 156, upon receipt of the initial authentication and authorization flow 170, the identity provider system 142 uses the identity information in the received authentication and authorization flow to identify a user device, such as user device 140, that may be contacted for authorization to release bootstrap credentials (keys) to the cloud management proxy device 130(1). That is, the identity provider system 142 includes a configuration so that the identity information in the received authentication can be mapped to at least one user device for the release of bootstrap credentials. In one example, this configuration is a database of mappings between cloud management proxy devices and user devices. As described further below, a cloud management proxy device may also be mapped to multiple user devices in, for example, a hierarchical or predetermined manner.

Returning to the specific example of FIG. 2, once the user device 140 is identified, the identity provider system 142 executes a credential release authorization process to obtain authorization/permission to initiate the release of bootstrap credentials to the cloud management proxy device 130(1). More specifically, the identity provider system 142 generates and sends (e.g., via a server) an authentication request to user device 140. This authentication request, which is shown in FIG. 3 by arrow 172, is a request for the user of the user device 140 to authorize the release of bootstrap credentials to the cloud management proxy device 130(1). In response to receiving the authentication request 172, at 158, the user device 140 presents the user with some form of an authentication challenge. This authentication challenge may comprise, for example, a request to enter one or more of a security code, password, user ID, or other type of credential.

Upon receiving the authentication challenge, the user at user device 140 has the ability to authorize the bootstrap credential release or, alternatively, if the user suspects something is not correct, then they may chose to abort the flow. That is, in response to the authentication challenge, at 160, the user enters one or more inputs at the user device 140 to trigger the user device 140 to generate and send an authentication response back to the identity provider system 142. The authentication response, which is shown in FIG. 3 by arrow 174, includes an indication of whether the user's entered inputs in response to the authentication challenge were correct/expected.

As shown in FIG. 2, at 162 a determination is made as to whether the user has authorized the release of the bootstrap credentials. Credential release authorization may fail, for example, when the user enters incorrect inputs, a time-out occurs, the user terminates the flow due to suspicions activity, each of which may identified in the authentication response. In the example of FIG. 2, the determination of whether the user has authorized the bootstrap credential release is performed at the identity provider system 142. However, it is to be appreciated that this determination could alternatively be performed at the user device 140 such that the authentication response 174 directly indicates to the identity provider system 142 whether or not the bootstrap credentials are to be released.

If it is determined that the user at user device 140 has not authorized the bootstrap credential release, then one or more remediation operations may be initiated. In one example, failure to obtain release authorization from the user triggers a notification to the cloud management proxy device 130(1) indicating that the remote credential release process failed or was terminated. In response to this notification, the cloud management proxy device 130(1) may, for example, terminate the boot operation, wait a period of time and resend the authentication and authorization flow. In accordance with other examples, if authorization to release the bootstrap credentials cannot be obtained (e.g., due to a time out), then the identity provider system 142 initiates a hierarchical or escalation workflow in an attempt to obtain authorization for the bootstrap credential release from one or more other users at other user devices. This example is shown in FIG. 2 where a failure to receive authorization for bootstrap credential release causes the method 150 to return to 156 where a new user and/or user device is selected from, for example, a predetermined group of users. The operations of 156, 158, 160, and 162 may be repeated until credential release authorization is obtained or until the identity provider system 142 determines that the process should be terminated (e.g., all predetermined users have failed to authorize release of the bootstrap credential, or a timer has expired).

Returning to 162, if it is determined that the user at user device 140 has authorized the bootstrap credential release, then the method 150 proceeds to 164 where the identity provider system 142 sends a credential release message to a remote credential manager system (e.g., an SAML-enabled key manager). Although shown separate in FIGS. 1 and 3, the remote credential manager 144, may, in certain examples, form part of the identity provider system 142.

The credential release message sent by the identity provider system 142, which is shown in FIG. 3 by arrow 176, triggers the credential manager 144 to, at 166, release the bootstrap credentials to the cloud management proxy device 130(1). That is, the credential manager 144 generates or otherwise obtains the bootstrap credentials needed by the cloud management proxy device 130(1) to complete the boot operation and sends a message that includes the bootstrap credentials directly or indirectly to the cloud management proxy device 130(1). The message that includes the bootstrap credentials, which is sometimes referred to as a bootstrap credential message, is shown in FIG. 3 by arrow 178. At 168, the cloud management proxy device 130(1) uses the bootstrap credentials within the bootstrap credential message 178 to complete its boot operation.

More particularly, the cloud management proxy device 130(1) decrypts the bootstrap credential message 178 (since it is sent using a secure mechanism such as HTTPs), extracts the bootstrap credentials, and uses the bootstrap credentials to decrypt local configuration and/or credential stores. The cloud management proxy device 130(1) then uses the decrypted configuration information to complete the boot operation.

As noted, the remote credential manager 144 is responsible for releasing the bootstrap credentials to the cloud management proxy device 130(1). In certain examples, the remote credential manager 144 can generate the bootstrap credentials or obtain all or part of the bootstrap credentials from a local credential store. In other examples, a split-key operation is used to generate the bootstrap credentials. In an example split-key operation, the user device is configured to provide key material that is used by the remote credential manager 144 to generate the bootstrap credentials. This key material, which may be a key forming part of the bootstrap credentials or some other underlying information used to generate all or a portion of the bootstrap credentials, may be provided to the identity provider system 142 in the authentication response 174. Therefore, in an example split-key operation, the user device 140 provides part of the key material (e.g., a password given on the mobile device or a key held on the user device) and another part of the key material comes from the remote credential manager 144. If it a split-key operation is used, in certain examples the cloud management proxy device 130(1) can perform one or more operations to build the final bootstrap credentials.

The remote credential release process may be used in a number of different circumstances and arrangements. In one example, the techniques presented herein are used for a partially attended restart with credential unlock. In another example, the techniques presented herein are used for the on-boarding flow of the cloud management proxy device 130(1). In one such example, an ephemeral key is present on the cloud management proxy device 130(1) and this ephemeral key is revoked after the bootstrap credentials are received. As such, the ephemeral key can only be used to generate the authentication and authorization flow. In general, the techniques do not require a user to physically log into the booting device while allowing customers to protect their security credentials.

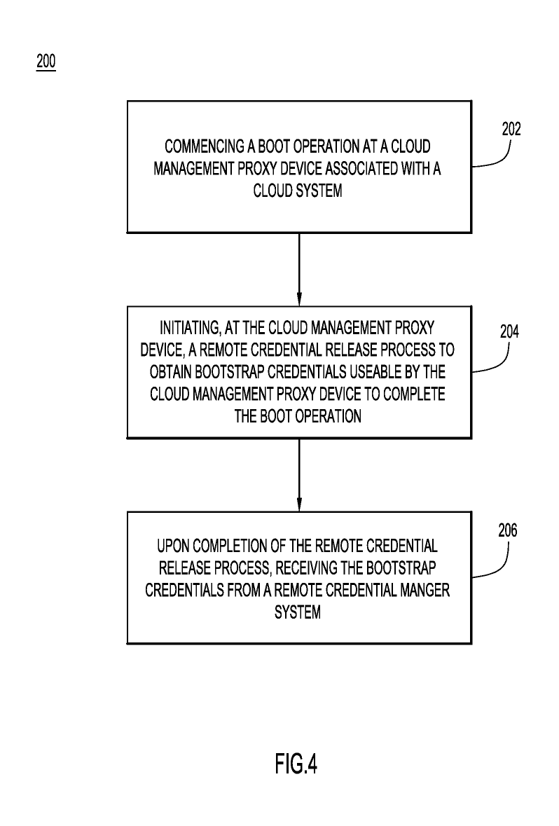

FIG. 4 illustrates a high-level flow chart of a process 200 that generalizes the concepts described above in connection with FIGS. 1-3. Reference is also made to FIG. 1 for purposes of this description. Process 200 begins at 202 where the cloud management proxy device 130(1) commences a boot operation. The cloud management proxy device 130(1) is associated with management entity 110 in cloud-based management system 100. At 204, the cloud management proxy device 130(1) initiates a remote credential release process to obtain bootstrap credentials useable by the cloud management proxy device 130(1) to complete the boot operation. At 206, upon completion of the remote credential release process, the cloud management proxy device 130(1) receives the bootstrap credentials from a remote credential manager.

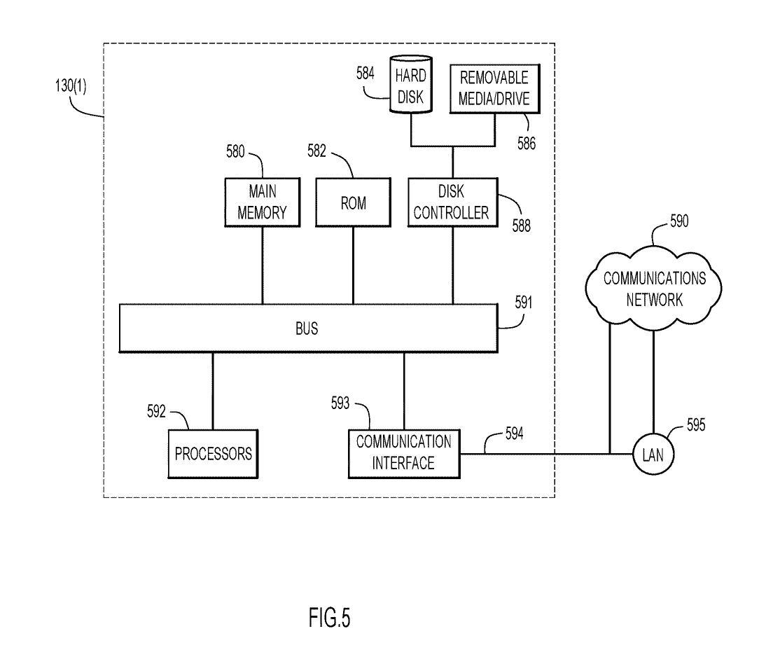

FIG. 5 is a block diagram illustrates an arrangement for a cloud management proxy device 130(1) upon which the embodiments presented may be implemented. The cloud management proxy device 130(1). The cloud management proxy device 130(1) includes a bus 591 or other communication mechanism for communicating information, and one or more processors 592 coupled with the bus 591 for processing the information. While FIG. 5 shows a single processor block 592, it should be understood that the processors 592 may represent a plurality of processing cores, each of which can perform separate processing operations. The cloud management proxy device 130(1) also includes a main memory 580, such as a random access memory (RAM) or other dynamic storage device (e.g., dynamic RAM (DRAM), static RAM (SRAM), and synchronous DRAM (SD RAM)), coupled to the bus 591 for storing information and instructions to be executed by the one or more processors 592. In addition, the main memory 580 may be used for storing temporary variables or other intermediate information during the execution of instructions by the one or more processors 592.

The cloud management proxy device 130(1) further includes a read only memory (ROM) 582 or other static storage device (e.g., programmable ROM (PROM), erasable PROM (EPROM), and electrically erasable PROM (EEPROM)) coupled to the bus 591 for storing static information and instructions for the one or more processors 592.

The cloud management proxy device 130(1) also includes a disk controller 588 coupled to the bus 591 to control one or more storage devices for storing information and instructions, such as a magnetic hard disk 584, and a removable media drive 586. The storage devices may be added to the cloud management proxy device 130(1) using an appropriate device interface (e.g., Universal Serial Bus (USB), small computer system interface (SCSI), integrated device electronics (IDE), enhanced-IDE (E-IDE), direct memory access (DMA), or ultra-DMA, etc.).

The cloud management proxy device 130(1) may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The cloud management proxy device 130(1) performs a portion or all of the processing steps of the process in response to the one or more processors 592 executing one or more sequences of one or more instructions contained in a memory, such as the main memory 580. Such instructions may be read into the main memory 580 from another computer readable medium, such as a hard disk 584 or a removable media drive 586. One or more processors in a multi-processing arrangement may also be employed to execute the sequences of instructions contained in main memory 580. In alternative embodiments, hard-wired circuitry may be used in place of or in combination with software instructions. Thus, embodiments are not limited to any specific combination of hardware circuitry and software.

As stated above, the cloud management proxy device 130(1) includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the cloud management proxy device 130(1), for driving a device or devices for implementing the process, and for enabling the cloud management proxy device 130(1). Such computer readable storage media further includes a computer program product for performing all or a portion (if processing is distributed) of the processing presented herein. The computer program product may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The cloud management proxy device 130(1) also includes a communication interface 593 coupled to the bus 591. The communication interface 593 provides a two-way data communication coupling to a network link 594 that is connected to, for example, a local area network (LAN) 595, or to another communications network 590 such as the Internet. For example, the communication interface 593 may be a wired or wireless network interface card to attach to any packet switched (wired or wireless) LAN. As another example, the communication interface 593 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 593 sends and receives electrical, electromagnetic or optical signals that carry digital data streams representing various types of information.

In summary, presented herein are techniques for using a remote credential release process to release bootstrap credentials to a cloud management proxy device. The techniques presented herein eliminate the prior art requirement for a user to log into, or manually unlock, a cloud management proxy device when a boots operation occurs. The techniques presented herein eliminate this requirement through remote authorization, while not compromising key protection.

In one form, a method is provided comprising: commencing a boot operation at a cloud management proxy device associated with a management entity in a cloud system; initiating, at the cloud management proxy device, a remote credential release process to obtain bootstrap credentials useable by the cloud management proxy device to complete the boot operation; and upon completion of the remote credential release process, receiving the bootstrap credentials from a remote credential manager.

In another form, a system is provided comprising: a cloud-based management entity; a cloud management proxy device associated with the cloud-based management entity, wherein the cloud management proxy device comprises: a communication interface, a memory, and one or more processors configured to commence a boot operation, initiate a remote credential release process to obtain bootstrap credentials to complete the boot operation, and receive the bootstrap credentials from a remote credential manager upon completion of the remote credential release process.

In still another form, one or more non-transitory computer readable storage media are provided encoded with instructions that, when executed by a processor, cause the processor to: commence a boot operation at a cloud management proxy device associated with a management entity in a cloud system; initiate, at the cloud management proxy device, a remote credential release process to obtain bootstrap credentials useable by the cloud management proxy device to complete the boot operation; and upon completion of the remote credential release process, receive the bootstrap credentials from a remote credential manager.

In yet another form, an apparatus is provided comprising: a communication interface, a memory, and one or more processors configured to: commence a boot operation, initiate a remote credential release process to obtain bootstrap credentials useable by the apparatus to complete the boot operation, and receive the bootstrap credentials from a remote credential manager upon completion of the remote credential release process.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
commencing a boot operation at a cloud management proxy device associated with a management entity in a cloud system;
initiating, at the cloud management proxy device, a remote credential release process to obtain bootstrap credentials useable by the cloud management proxy device to complete the boot operation; and
upon completion of the remote credential release process, receiving the bootstrap credentials from a remote credential manager.

2. The method of claim 1, further comprising:
completing the boot operation using the bootstrap credentials received from the remote credential manager.

3. The method of claim 1, wherein initiating the remote credential release process comprises:
sending an initial authentication and authorization flow to the management entity of the cloud system.

4. The method of claim 3, further comprising:
re-directing the initial authentication and authorization flow to an identity management system that identifies a user device associated with the cloud management proxy device and a user authorized to release the bootstrap credentials to the cloud management proxy device, and executes a credential release authorization process with the user device.

5. The method of claim 4, wherein executing the credential release authorization process comprises:
sending an authorization request to the user device;
receiving an authorization response from the user device, wherein the authorization response is generated based on one or more user inputs; and
determining, based on the authorization response, if release of the bootstrap credentials has been authorized by the user.

6. The method of claim 5, wherein when it is determined that release of the bootstrap credentials has not been authorized by the user, the method further comprises:
executing a hierarchical workflow to obtain authorization for release of the bootstrap credentials from one or more other users associated with the cloud management proxy device.

7. The method of claim 4, further comprising:
upon receiving an authorization to release the bootstrap credentials, obtaining the bootstrap credentials at the remote credential manager; and
sending the bootstrap credentials to the cloud management proxy device.

8. The method of claim 4, further comprising:
executing a split-key operation to generate the bootstrap credentials.

9. The method of claim 1, wherein the cloud system is a network security management cloud system, and wherein the cloud management proxy device controls access to security credentials for customer network security devices associated with the network security management cloud system.

10. A system comprising:
a cloud-based management entity; and
a cloud management proxy device associated with the cloud-based management entity, wherein the cloud management proxy device comprises:
a communication interface,
a memory, and
one or more processors configured to commence a boot operation, initiate a remote credential release process to obtain bootstrap credentials to complete the boot operation, and receive the bootstrap credentials from a remote credential manager upon completion of the remote credential release process.

11. The system of claim 10, wherein the one or more processors are configured to complete the boot operation using the bootstrap credentials received from the remote credential manager.

12. The system of claim 10, wherein to initiate the remote credential release process, the one or more processors are configured to:
send an initial authentication and authorization flow to the management entity of the cloud system.

13. The system of claim 12, wherein the initial authentication and authorization flow is redirected to an identity management system that identifies a user device associated with the cloud management proxy device and a user authorized to release the bootstrap credentials to the cloud management proxy device, and executes a credential release authorization process with the user device.

14. The system of claim 13, wherein to execute the credential release authorization process, the identity management system is configured to:
send an authorization request to the user device;
receive an authorization response from the user device, wherein the authorization response is generated based on one or more user inputs; and
determine, based on the authorization response, if release of the bootstrap credentials has been authorized by the user.

15. The system of claim 14, wherein when it is determined that release of the bootstrap credentials has not been authorized by the user, the identity management system is configured to:
execute a hierarchical workflow to obtain authorization for release of the bootstrap credentials from one or more other users associated with the cloud management proxy device.

16. The system of claim 13, wherein upon receiving an authorization to release the bootstrap credentials, the remote credential manager is configured to obtain the bootstrap credentials and send the bootstrap credentials to the cloud management proxy device.

17. The system of claim 13, wherein upon receiving an authorization to release the bootstrap credentials, the remote credential manager the remote credential manager is configured to execute a split-key operation to generate the bootstrap credentials.

18. The system of claim 10, wherein the cloud-based management entity is part of a network security management cloud system, and wherein the cloud management proxy device controls access to security credentials for customer network security devices associated with the network security management cloud system.

19. One or more non-transitory computer readable storage media encoded with instructions that, when executed by a processor, cause the processor to:
commence a boot operation at a cloud management proxy device associated with a management entity in a cloud system;
initiate, at the cloud management proxy device, a remote credential release process to obtain bootstrap credentials useable by the cloud management proxy device to complete the boot operation; and
upon completion of the remote credential release process, receive the bootstrap credentials from a remote credential manager.

20. The computer readable storage media of claim 19, further comprising instructions operable to:
complete the boot operation using the bootstrap credentials received from the remote credential manager.

21. The computer readable storage media of claim 19, wherein the instructions operable to initiate the remote credential release process comprise instructions operable to:
send an initial authentication and authorization flow to the management entity of the cloud system.

22. The computer readable storage media of claim 19, wherein the cloud system is a network security management cloud system, and wherein the cloud management proxy device controls access to security credentials for customer network security devices associated with the network security management cloud system.
